(19) United States
(12) Patent Application Publication
(10) Pub. No.: US 2025/0289727 A1
(43) Pub. Date: Sep. 18, 2025

(54) HIGH ENTROPY OXIDES AND METHODS OF SYNTHESIS AND USE THEREOF

(71) Applicant: University of Hawaii, Honolulu, HI (US)

(72) Inventors: Tyler Ray, Honolulu, HI (US); Ziyu Yin, Honolulu, HI (US)

(21) Appl. No.: 18/861,410

(22) PCT Filed: May 5, 2023
(86) PCT No.: PCT/US2023/066664

§ 371 Date: Oct. 29, 2024

Related U.S. Application Data
(60) Provisional application No. 63/339,068, filed on May 6, 2022.

(51) Int. Cl. C01G 3/02; B82B 1/00; B82Y 15/00; C01G 45/02; C01G 49/02; C01G 51/04; C01G 53/04

(52) U.S. Cl. CPC C01G 3/02; B82B 1/00; B82Y 15/00; C01G 45/02; C01G 49/02; C01G 51/04; C01G 53/04

(57) ABSTRACT

The present invention provides compositions and nanomaterials comprising a metal based high entropy oxide comprising at least five metals and their oxides distributed in a crystal structure, with high configurational entropy, a high number of oxygen vacancies and active catalytic sites. The present invention also relates to methods of synthesis of said compositions and nanomaterials using microwave irradiation and methods of use of said compositions and nanomaterials in analyte sensing as nanozymes, electrochemical sensors, and colorimetric sensors.

### CROSS REFERENCE TO RELATED APPLICATIONS

This application claims priority to and the benefit of U.S. Provisional Application No. 63/339,068, filed May 6, 2022, the disclosure of which is incorporated herein by reference herewith in its entirety.

### STATEMENT REGARDING FEDERALLY SPONSORED RESEARCH OR DEVELOPMENT

This invention was made with government support under P20 GM113134 awarded by the National Institute of Health. The government has certain rights in the invention.

### BACKGROUND OF THE INVENTION

High entropy oxides (HEOs), a derivative concept of high entropy alloys (HEAs), are based on the incorporation of five or more different cations in a single-lattice structure with possible synergistic effects. HEOs, comprising five or more elements randomly distributed throughout a crystal structure in equimolar or near-equimolar ratios, exhibit great physiochemical properties in many applications, including electronics, energy storage and conversion, and catalysis. Transition metal elements, such as copper (Cu), cobalt (Co), iron (Fe), nickel (Ni), and manganese (Mn), and their oxides are well studied as electrochemical catalysts, and serve as representative HEOs with robust catalytically active centers for multiple catalytic reactions. The entropy maximization principle has driven extraordinary physicochemical properties within the combinational of metal cations and non-metal anions favored by their high configurational entropy. It is worthy to note that the cocktail effect from multiple active components, severe lattice distortion effect and tunable d-band center, and great number of oxygen vacancies in the active catalytic center of HEOs facilitate the activation and transfer of active species for catalytic performance. Exact size and morphology control of HEOs in nanoscale structures during synthesis would offer abundant active defects and large surface area for excellent catalytic activities. In addition, nanostructured materials with high surface areas prompt density of the exposed active sites and enhance mass diffusion efficiency, leading to facilitated catalytic performance.

HEOs have attracted significant interests for their multifunctional behavior and dielectric, thermal, catalytic, and magnetic properties. Typical methods used to synthesize HEOs include solid-state reactions, flame spray pyrolysis, nebulized spray pyrolysis, and co-precipitation synthesis. Notwithstanding, these methods suffer from the need for expensive and complicated equipment, high energy consumption, prolonged processing time, low repeatability, and large particle size. Conventional approaches for the synthesis of HEOs require not only special experimental equipment and complicated preparation processes, but also operate at extremely high temperature and tend to micron-scale agglomerated particles with low surface areas and are still far from satisfactory of their efficient catalytic activity.

HEOs inherit unique features from various numerous active elements and beneficial synergistic effects and have more induced defective structures as catalytically active sites, leading to ever-increasing attention for various applications. However, studies primarily report HEOs as electrocatalysts for energy conversion such as in oxygen evolution reactions and water splitting. Therefore, maximizing the use potential of HEOs for efficient catalytic application is still in infancy, especially efficient analysis of biomolecules. Owing to the great distribution of multi-components and disordered structural characteristics, the HEOs offer a promising interconnected possibility for tuning the functional properties of catalysts. In virtue of being nanostructured, rich in oxygen vacancies, and having a large surface area and abundant active sites, the multifunctional HEOs could represent a promising platform for enhanced synergistic multimodal functional target detection. Nanozymes are a substitute for natural enzymes in many biochemical reactions and their catalytic activity performance and detection of mechanisms in biomolecular detection are of vital importance for their standardization as protocols for replacing natural enzymes in the future. They hold great opportunities to break through obstacles from natural enzymes whose activity and stability depend on ambient temperature and pH, increasing attention from researchers owing to their low cost, high stability, and great catalytic activity. The connection of the concept of nanozymes to HEOs, identification of real catalytic active sites, and unveiling of the catalytic mechanism during their catalytic performance has not yet been done. HEOs with attractive catalytic properties could be utilized as nanozymes to replace the function of natural enzymes for target analyte sensing, molecule monitoring, and early diagnosis.

Cortisol, a glucocorticoid hormone that regulates many aspects of metabolism, stress, and immune response, is closely related to various diseases and disorders. Mainstreamed strategies for quantification of cortisol employ antibody-antigen immunological assay with enzymes, enzyme fragments, and/or specific aptamers to amplify biorecognition signals and improve sensitivity and selectivity. However, while immunoassays and immunosensors present satisfactory responses and cover a great concentration range, they generally suffer some drawbacks of stability, price and even by the time of constructing the biosensor. The investigation of electrochemical non-enzymatic cortisol sensing platforms is a promising and underexplored area of research.

Thus, there is a need in the art for improved compositions and methods for the synthesis and use of nanostructured HEOs. This invention satisfies this unmet need.

### BRIEF DESCRIPTION OF THE DRAWINGS

The following detailed description of embodiments of the invention will be better understood when read in conjunction with the appended drawings. It should be understood that the invention is not limited to the precise arrangements and instrumentalities of the embodiments shown in the drawings.

FIG. 1 depicts a schematic diagram of the synthesis of high entropy oxides (HEOs) via a microwave assisted solvothermal method and its applications in electrochemical and colorimetric sensors for multiple targets monitoring.

FIG. 2 depicts high resolution 2 p spectra for Fe 2 p, Mn 2 p, Co 2 p, and Ni 2 p for HEOs.

FIG. 3, comprising FIG. 3A through FIG. 3C, depicts surface morphologies of HEOs. FIG. 3A depicts scanning electron microscopy (SEM) images of HEOs. FIG. 3B depicts transmission electron microscopy (TEM) images of HEOs. FIG. 3C depicts energy dispersive x-ray (EDX) element mapping of oxygen, iron, manganese, cobalt, nickel, and copper of an HEO sample. Scale bar: 2.5 mm.

FIG. 4, comprising FIG. 4A through FIG. 4C, depicts surface morphologies of HEOs/graphene oxide (GO). FIG. 4A depicts SEM images wherein red arrows indicate dispersed HEOs. FIG. 4B depicts TEM images wherein red dashed circles indicate dispersed HEOs for size measuring. FIG. 4C depicts the size distribution of HEOs on GO.

FIG. 5 depicts an EDX spectrum of an HEO sample.

FIG. 6, comprising FIG. 6A and FIG. 6B, depicts phase composition spectra of HEO samples. FIG. 6A depicts x-ray (XRD) pattern of an HEO sample. FIG. 6B depicts x-ray photoelectron spectroscopy (XPS) survey spectra for HEOs/GO and HEOs.

FIG. 7 depicts the XRD pattern of HEO/GOs.

FIG. 8 depicts a high resolution 1 s spectrum of oxygen for HEOs and HEOs/GO.

FIG. 9, comprising FIG. 9A through 9D, depicts electrochemical performance of HEOs/GO/screen-printed electrodes (SPEs). FIG. 9A depicts the amperometric response of HEOs/GO/SPE as nonimmunological electrochemical sensor for cortisol detection at applied potential 0.35 V (vs. Ag/AgCl). FIG. 9B depicts a zoom in to the rectangular area of FIG. 9A in the low concentration range of cortisol. FIG. 9C depicts a corresponding calibration curve for cortisol detection. FIG. 9D depicts a zoom in to the rectangular area I of FIG. 9C for the linear range of detecting cortisol concentration (0.01˜4.01 μM). Amperometric measurements of cortisol were performed using an alkaline NaOH solution as the supporting electrolyte. Cortisol solutions were added in successive steps to the stirring electrolyte solution at an applied potential 0.35 V, resulting in real-time responsive current signals that were periodically recorded. By measuring the changes in cortisol signals upon adding different concentrations of cortisol, the sensor was able to detect and quantify cortisol levels.

FIG. 10, comprising FIG. 10A and 10B, depicts additional electrochemical cortisol detection responses of HEOs/GO/SPEs. FIG. 10A depicts a zoom in to the rectangular area II of FIG. 9C for the linear range of detecting cortisol concentration (4.01˜17.93 μM). FIG. 10B depicts a zoom in to the rectangular area III of FIG. 9C for the linear range of detecting cortisol concentration (17.93˜36.38 μM).

FIG. 11, comprising FIG. 11A and FIG. 11B, depicts electrochemical dependence on scan rate. FIG. 11A depicts the linear dependence of the peak current on the voltage scan rate under various cortisol systems. FIG. 11B depicts the dependence of the peak potential shift on the scan rate. The electron transfer rate of redox reactions was determined using cyclic voltammetry (CV) data-processing algorithm based on the extended Marcus theory. The experiments were conducted in 0.1 M NaOH electrolyte with various cortisol systems.

FIG. 12, comprising FIG. 12A through FIG. 12D, depicts electrocatalytic properties of HEOs. FIG. 12A depicts an evaluation of the electrochemical active surface area (ESCA) of SPE, HEOs/SPE, and HEOs/GO/SPE by performing CV at different scan rates in 5 mM potassium ferri/ferrocyanide using 0.1 M KCl as the electrolyte. FIG. 12B depicts Nyquist plots of SPE, HEOs/SPE, and HEOs/GO/SPE, which was performed in 0.1 M KCl and 5 mM [Fe(CN)₆]^{3-/4-} by setting the working electrode voltage at 0.0 V vs the reference electrode Ag/AgCl within the frequency range from 100 kHz to 0.1 Hz. FIG. 12C depicts the cyclic voltammograms recorded in the presence of cortisol by HEOs/GO/SPE system. FIG. 12D depicts a zoom in of the rectangular area in FIG. 12C for identifying significant signal potential position.

FIG. 13, comprising FIG. 13A and FIG. 13B, depicts a schematic illustration of electrochemical assays. FIG. 13A depicts a schematic for the mechanism for electrochemical cortisol assays. FIG. 13B depicts a schematic for the mechanism for (i) colorimetric H₂O₂ assays and (ii) glutathione (GSH) assays.

FIG. 14, comprising FIG. 14A through FIG. 14F, depicts ultraviolet-visible (UV-Vis) spectra for H₂O₂ and GSH detection. FIG. 14A depicts UV-absorbance curves of HEOs (150° C., 0.02 mg/ml) and 3,3′,5,5′-tetramethylbenzidine (TMB) (0.1 mM) with various concentrations of H₂O₂ (0.005, 0.01, 0.02, 0.05, 0.1, 0.2, 0.5, 1, 2, 5, 10 mM). FIG. 14B depicts the absorbance values at 652 nm for different concentrations of H₂O₂ and the correlation curve in FIG. 14C. FIG. 14C depicts the linear correlation curve of H₂O₂ at various concentrations (5˜1000 μM). FIG. 14D depicts the typical UV-vis spectrum of HEOs/TMB/H₂O₂ system at various GSH concentrations (0.01, 0.05, 0.1, 0.5, 1, 2, 5, 7, 10, 15, 20, 25, 30, 50, 100, 150, 200 μM). FIG. 14E depicts the concentration response for GSH detection. FIG. 14F depicts the linear calibration plot (0.01˜25 μM) for GSH detection using HEOs (150° C., 0.02 mg/ml).

FIG. 15, comprising FIG. 15A and FIG. 15B, depicts the enzyme mimetic activity of HEOs. FIG. 15A depicts UV-Vis spectra of TMB, TMB+H₂O₂, HEO catalyst+TMB, and HEO catalyst+TMB+H₂O₂, where the reaction system was carried out under 0.2 M acetate buffer solution (pH 4.0). FIG. 15B depicts dependence of peroxidase like activity of HEOs on pH, with fixed concentration of HEO catalyst (0.02 mg/ml), TMB (0.1 mM) and H₂O₂ (10 mM).

FIG. 16, comprising FIG. 16A and FIG. 16B, depicts stability and reproducibility tests of HEOs/GO. FIG. 16A depicts stability testing of HEOs/GO towards 15 μM cortisol over 20 days. FIG. 16B depicts reproducibility testing of HEOs/GO towards 10 μM cortisol across five batches. To evaluate the stability of HEOs/GO towards cortisol detecting over 20 days, HEOs/GO were exposed to a constant temperature of 25° C. in an ambient environment while monitoring its output signal. To evaluate the reproducibility of the sensor, five batches were prepared using the same protocol and materials and output signals of each sensor were tested in response to a standard analyte concentration.

FIG. 17, comprising FIG. 17A through FIG. 17D, depicts steady-state kinetic assays of HEOs (150° C., 0.02 mg/ml). FIG. 17A depicts a plot of the initial velocity against TMB concentration, in which H₂O₂ concentration was fixed at 10 mM, fitted by a Michaelis-Menten model. FIG. 17B depicts double reciprocal plots of FIG. 17A fitted by a Lineweaver-Burk model.

FIG. 17C depicts a plot of the initial velocity against H₂O₂ concentration, in which TMB concentration was fixed at 0.1 mM, fitted by a Michaelis-Menten model. FIG. 17D depicts double reciprocal plots of FIG. 17C fitted by a Lineweaver-Burk model. The error bars indicate the scatter in the data over three repetitions.

FIG. 18 depicts UV-Vis spectra across time for 50 μM GSH, L-Cystine (L-Cys), and ascorbic acid (AA), wherein the control represents only hydrogen peroxide without the presence of GSH, L-Cys, or AA.

FIG. 19 depicts testing of the catalytic mechanism of peroxidase mimicking with 2 mM radical scavengers (e.g., 1,4-benzoquinone (superoxide anion radical, O₂^{·-}), ethylenediaminetetraacetic acid (hole, h⁺), isopropyl alcohol (hydroxyl radical, ·OH), and L-Tryptophan (singlet oxygen, ¹O₂)).

### DETAILED DESCRIPTION

### Definitions

Unless defined otherwise, all technical and scientific terms used herein have the same meaning as commonly understood by one of ordinary skill in the art to which this invention belongs.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary.

Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions disclosed herein. Thus, if there are a variety of additional steps that can be performed it is understood that each of these additional steps can be performed with any specific embodiment or combination of embodiments of the methods disclosed herein.

### Metal Based High Entropy Oxides and Compositions Thereof

In one aspect, the present invention provides a composition comprising a metal based high entropy oxide comprising at least five metals and their oxides distributed in a crystal structure. In several embodiments, the composition has high configurational entropy. In some embodiments, the composition has a high number of oxygen vacancies. In some embodiments, the composition possesses an active catalytic center. In some embodiments, the composition is nanostructured. In some embodiments, the composition is a nanomaterial.

In several embodiments, the at least five metals are transition metals. Exemplary metals of the composition include but are not limited to titanium, vanadium, chromium, manganese, iron, cobalt, nickel, copper, zinc, zirconium, niobium, molybdenum, technetium, ruthenium, rhodium, palladium, silver, cadmium, hafnium, tantalum, tungsten, rhenium, osmium, iridium, platinum, gold, combinations thereof, oxides thereof, and any oxidation state thereof. In some embodiments, the at least five metals are iron, cobalt, manganese, nickel, and copper. In one embodiment, the ratio of iron to cobalt to manganese to nickel to copper is about 1:1:1:1:1. In one embodiment, the ratio of iron to cobalt to manganese to nickel to copper is about 2:1:1:1:1. In one embodiment, the ratio of iron to cobalt to manganese to nickel to copper is about 1:2:1:1:1. In one embodiment, the ratio of iron to cobalt to manganese to nickel to copper is about 1:1:2:1:1. In one embodiment, the ratio of iron to cobalt to manganese to nickel to copper is about 1:1:1:2:1. In one embodiment, the ratio of iron to cobalt to manganese to nickel to copper is about 1:1:1:1:2. In one embodiment, the ratio of iron to cobalt to manganese to nickel to copper is about 2:2:1:1:1. In one embodiment, the ratio of iron to cobalt to manganese to nickel to copper is about 1:2:2:1:1. In one embodiment, the ratio of iron to cobalt to manganese to nickel to copper is about 1:1:2:2:1. In one embodiment, the ratio of iron to cobalt to manganese to nickel to copper is about 1:1:1:2:2. In one embodiment, the ratio of iron to cobalt to manganese to nickel to copper is about 2:1:1:1:2. In one embodiment, the ratio of iron to cobalt to manganese to nickel to copper is about 2:2:2:1:1. In one embodiment, the ratio of iron to cobalt to manganese to nickel to copper is about 1:2:2:2:1. In one embodiment, the ratio of iron to cobalt to manganese to nickel to copper is about 1:1:2:2:2. In one embodiment, the ratio of iron to cobalt to manganese to nickel to copper is about 2:1:1:2:2. In one embodiment, the ratio of iron to cobalt to manganese to nickel to copper is about 2:2:1:1:2. In one embodiment, the ratio of iron to cobalt to manganese to nickel to copper is about 2:2:2:2:1. In one embodiment, the ratio of iron to cobalt to manganese to nickel to copper is about 1:2:2:2:2. In one embodiment, the ratio of iron to cobalt to manganese to nickel to copper is about 2:1:2:2:2. In one embodiment, the ratio of iron to cobalt to manganese to nickel to copper is about 2:2:1:2:2. In one embodiment, the ratio of iron to cobalt to manganese to nickel to copper is about 2:2:2:1:2.

In several embodiments, the composition is carbon supported. In some embodiments, the composition is dispersed on graphene oxide. In some embodiments, the composition is dispersed on graphene oxide using ultrasonication. In one embodiment, the composition is dispersed on graphene oxide manually.

In one embodiment, the average size of the particles of the composition on graphene oxide is about 8 to 9 nm. In one embodiment, the average size of the particles of the composition on graphene oxide is about 9 to 10 nm. In one embodiment, the average size of the particles of the composition on graphene oxide is about 10 to 11 nm. In one embodiment, the average size of the particles of the composition on graphene oxide is about 11 to 12 nm. In one embodiment, the average size of the particles of the composition on graphene oxide is about 12to 13 nm. In one embodiment, the average size of the particles of the composition on graphene oxide is about 13 to 14 nm. In one embodiment, the average size of the particles of the composition on graphene oxide is about 14 to 15 nm. In one embodiment, the average size of the particles of the composition on graphene oxide is about 15 to 16 nm. In one embodiment, the average size of the particles of the composition on graphene oxide is about 16 to 17 nm. In some embodiments, the composition is face-centered cubic. In some embodiments, the composition is body-centered cubic. In some embodiments, the composition is primitive cubic.

In one aspect, the present invention relates to an electrochemical sensor comprising a composition described herein. In some embodiments, the electrochemical sensor is an electrocatalyst. In some embodiments, the electrochemical sensor is a nanozyme. In some embodiments, the electrochemical sensor is used to detect analytes in a solution. In one embodiment, the analyte is a protein. In one embodiment, the analyte is an oxidant. In one embodiment, the analyte is an antioxidant. In one embodiment, the analyte is a hormone. In one embodiment, the analyte is an amino acid. In one embodiment, the analyte is cortisol. In one embodiment, the solution is aqueous. In one embodiment, the solution is organic. In one embodiment, the solution is a bodily fluid. Exemplary bodily fluids include, but are not limited to, sweat, whole blood, urine, stool, saliva, lymph fluid, cerebrospinal fluid, synovial fluid, cystic fluid, ascites, pleural effusion, fluid obtained from a pregnant woman in the first trimester, fluid obtained from a pregnant woman in the second trimester, fluid obtained from a pregnant woman in the third trimester, maternal blood, amniotic fluid, chorionic villus sample, fluid from a preimplantation embryo, maternal urine, maternal saliva, placental sample, fetal blood, lavage, cervical vaginal fluid, interstitial fluid, ocular fluid, blood, plasma, serum, sputum, feces, semen, mucous, lymph, nasal lavage, eye lavage, peritoneal cavity lavage, vaginal lavage, bladder lavage, rectal lavage, fine needle aspiration of spinal fluid, and synovial fluid aspiration. In one embodiment, the solution is sweat.

In some embodiments, the electrochemical sensor is carbon supported. In one embodiment, the electrochemical sensor is carbon supported on graphene oxide. In one embodiment, the electrochemical sensor is dispersed onto graphene oxide. In one embodiment, the graphene oxide is a sheet. In one embodiment, the graphene oxide is two-dimensional. In one embodiment, the graphene oxide is planar. In one embodiment, the electrochemical sensor is ultrasonicated with graphene oxide. In one embodiment, the electrochemical sensor is manually dispersed onto the graphene oxide. In some embodiments, the electrochemical sensor is drop-cast onto SPEs. In some embodiments, the electrochemical sensor performs non-immunological detection of analytes.

In one aspect, the present invention also relates to a colorimetric sensor comprising a composition described herein. In several embodiments, the colorimetric sensor is an enzyme mimic. In some embodiments, the colorimetric sensor acts as a nanozyme. In some embodiments, the colorimetric sensor is a peroxidase mimic. In some embodiments, the electrochemical sensor is used to detect analytes in a solution. In one embodiment, the analyte is a protein. In one embodiment, the analyte is an oxidant. In one embodiment, the analyte is an antioxidant. In one embodiment, the analyte is a hormone. In one embodiment, the analyte is an amino acid. In one embodiment, the analyte is hydrogen peroxide. In one embodiment, the analyte is glutathione. In one embodiment, the solution is aqueous. In one embodiment, the solution is organic. In one embodiment, the solution is a bodily fluid. Exemplary bodily fluids include, but are not limited to, sweat, whole blood, urine, stool, saliva, lymph fluid, cerebrospinal fluid, synovial fluid, cystic fluid, ascites, pleural effusion, fluid obtained from a pregnant woman in the first trimester, fluid obtained from a pregnant woman in the second trimester, fluid obtained from a pregnant woman in the third trimester, maternal blood, amniotic fluid, chorionic villus sample, fluid from a preimplantation embryo, maternal urine, maternal saliva, placental sample, fetal blood, lavage, cervical vaginal fluid, interstitial fluid, ocular fluid, blood, plasma, serum, sputum, feces, semen, mucous, lymph, nasal lavage, eye lavage, peritoneal cavity lavage, vaginal lavage, bladder lavage, rectal lavage, fine needle aspiration of spinal fluid, and synovial fluid aspiration.

Method of Synthesis

The present invention is further drawn to, in part, a method of synthesizing the composition comprising at least five metals and their oxides distributed in a crystal structure, which comprises the steps of combining in a reaction medium at least five metal salts, adding a surfactant to the reaction medium, adding a compound which contains at least one carbonyl to the reaction medium, and exposing the reaction medium to microwave irradiation.

In several embodiments, the reaction medium comprises at least one solvent. Exemplary solvents include glycols (e.g. ethylene glycol, propylene glycol, etc.), water, acrylates, alcohols, and combinations thereof. In some embodiments, the reaction medium comprises ethylene glycol and water. In one embodiment, the ratio of ethylene glycol to water is about 1:1 v/v. In one embodiment, the ratio of ethylene glycol to water is about 1:1.5 v/v. In one embodiment, the ratio of ethylene glycol to water is about 1:2 v/v. In one embodiment, the ratio of ethylene glycol to water is about 0.5:1.5 v/v. In one embodiment, the ratio of ethylene glycol to water is about 1.5:1 v/v. In one embodiment, the ratio of ethylene glycol to water is about 2:1 v/v. In one embodiment, the ratio of ethylene glycol to water is about 1.5:1 v/v.

In several embodiments, the metals of the at least five metal salts are transition metals. Exemplary metals include, but are not limited to, titanium, vanadium, chromium, manganese, iron, cobalt, nickel, copper, zinc, zirconium, niobium, molybdenum, technetium, ruthenium, rhodium, palladium, silver, cadmium, hafnium, tantalum, tungsten, rhenium, osmium, iridium, platinum, gold, combinations thereof, oxides thereof, and any oxidation state thereof.

In some embodiments, the at least five metals are iron, cobalt, manganese, nickel, and copper. In one embodiment, the ratio of iron to cobalt to manganese to nickel to copper is about 1:1:1:1:1. In one embodiment, the ratio of iron to cobalt to manganese to nickel to copper is about 2:1:1:1:1. In one embodiment, the ratio of iron to cobalt to manganese to nickel to copper is about 1:2:1:1:1. In one embodiment, the ratio of iron to cobalt to manganese to nickel to copper is about 1:1:2:1:1. In one embodiment, the ratio of iron to cobalt to manganese to nickel to copper is about 1:1:1:2:1. In one embodiment, the ratio of iron to cobalt to manganese to nickel to copper is about 1:1:1:1:2. In one embodiment, the ratio of iron to cobalt to manganese to nickel to copper is about 2:2:1:1:1. In one embodiment, the ratio of iron to cobalt to manganese to nickel to copper is about 1:2:2:1:1. In one embodiment, the ratio of iron to cobalt to manganese to nickel to copper is about 1:1:2:2:1. In one embodiment, the ratio of iron to cobalt to manganese to nickel to copper is about 1:1:1:2:2. In one embodiment, the ratio of iron to cobalt to manganese to nickel to copper is about 2:1:1:1:2. In one embodiment, the ratio of iron to cobalt to manganese to nickel to copper is about 2:2:2:1:1. In one embodiment, the ratio of iron to cobalt to manganese to nickel to copper is about 1:2:2:2:1. In one embodiment, the ratio of iron to cobalt to manganese to nickel to copper is about 1:1:2:2:2. In one embodiment, the ratio of iron to cobalt to manganese to nickel to copper is about 2:1:1:2:2. In one embodiment, the ratio of iron to cobalt to manganese to nickel to copper is about 2:2:1:1:2. In one embodiment, the ratio of iron to cobalt to manganese to nickel to copper is about 2:2:2:2:1. In one embodiment, the ratio of iron to cobalt to manganese to nickel to copper is about 1:2:2:2:2. In one embodiment, the ratio of iron to cobalt to manganese to nickel to copper is about 2:1:2:2:2. In one embodiment, the ratio of iron to cobalt to manganese to nickel to copper is about 2:2:1:2:2. In one embodiment, the ratio of iron to cobalt to manganese to nickel to copper is about 2:2:2:1:2.

In several embodiments, the at least five metal salts comprise a ligand. In several embodiments, the ligands of the at least five metal salts are bidentate ligands. Exemplary bidentate ligands include, but are not limited to, diketones, anhydrides, oxalates, diamines, diphosphines, bipyridines, phenanthrolines, catecholates, combinations thereof, derivatives thereof, substituted variants thereof, and ions thereof. In some embodiments, the ligand is a diketone. In one embodiment, the ligand is acetylacetonate. In some embodiments, the ligands of the at least five metal salts are monodentate ligands.

In some embodiments, the ligand is acetylacetone. In some embodiments, the ligand inhibits hydrolysis. In some embodiments, the ligand prevents rapid precipitation. In some embodiments, the ligand assists in architecture formation of the composition. In some embodiments, the ligand promotes mesoporosity of the composition.

In several embodiments, the compound which contains at least one carbonyl is decomposed when microwaved. In some embodiments, the compound releases carbon dioxide gas. In some embodiments, the compound releases carbon dioxide gas when heated above about 25° C. In some embodiments, the compound increases pressure of the system. In some embodiments, the compound forms a weak alkaline buffer in the reaction medium. In some embodiments, the compound inhibits hydrolysis of the ligand. In some embodiments, the compound inhibits random growth of the composition. In some embodiments, the compound assists in architecture formation of the composition. In some embodiments, the compound promotes mesoporosity of the composition. In one embodiment, the compound is an ester. In one embodiment, the compound is an amide. In one embodiment, the compound is an aldehyde. In one embodiment, the compound is a carboxylic acid. In one embodiment, the compound is an acid halide. In one embodiment, the compound is an anhydride. In one embodiment, the compound is a thioester. In one embodiment, the compound comprises a thiocarbonyl group. In one embodiment, the compound is a salt. In one embodiment, the compound comprises a carbonate. In one embodiment the compound comprises a bicarbonate. Exemplary compounds include, but are not limited to, urea, phosgene, oxalyl chloride, and triphosgene. In one embodiment, the compound is urea. In some embodiments, the compound is thiourea. In one embodiment, the compound is guanidine. In one embodiment, the compound is formamide. In one embodiment, the compound is triethanolamine.

In some embodiments, the concentration of the compound which contains at least one carbonyl in the reaction medium is about 0.01 M to about 0.50 M. In one embodiment, the concentration of the compound which contains at least one carbonyl in the reaction medium is about 0.01 to about 0.40 M. In one embodiment, the concentration of the compound which contains at least one carbonyl in the reaction medium is about 0.01 to about 0.30 M. In one embodiment, the concentration of the compound which contains at least one carbonyl in the reaction medium is about 0.01 to about 0.20 M. In one embodiment, the concentration of the compound which contains at least one carbonyl in the reaction medium is about 0.05 to about 0.20 M. In one embodiment, the concentration of the compound which contains at least one carbonyl in the reaction medium is about 0.05 to about 0.15 M. In one embodiment, the concentration of the compound which contains at least one carbonyl in the reaction medium is about 0.05 to about 0.10 M. In one embodiment, the concentration of the compound which contains at least one carbonyl in the reaction medium is about 0.10 to about 0.15 M. In one embodiment, the concentration of the compound which contains at least one carbonyl in the reaction medium is about 0.10 M.

In some embodiments, the surfactant is an ionic salt. In some embodiments, the surfactant is a non-ionic salt. In some embodiments, the surfactant is a zwitterionic salt. In some embodiments, the surfactant is hydrophilic. In some embodiments, the surfactant has negative polarity. In some embodiments, the surfactant has neutral polarity. Exemplary surfactants include, but are not limited to, esters, alkyloxylates, aliphatic acid esters, aliphatic acids, aliphatic amines, quaternary amines, organosilicones, combinations thereof, and derivatives thereof. In some embodiments, the surfactant is a chloride salt. In some embodiments, the surfactant is a bromide salt. In some embodiments, the surfactant is cetyltrimethylammonium chloride.

In some embodiments, the concentration of the surfactant in the reaction medium is about 0.01 M to about 0.50 M. In some embodiments, the concentration of the surfactant in the reaction medium is about 0.05 M to about 0.50 M. In some embodiments, the concentration of the surfactant in the reaction medium is about 0.10 M to about 0.50 M. In some embodiments, the concentration of the surfactant in the reaction medium is about 0.15 M to about 0.50 M. In some embodiments, the concentration of the surfactant in the reaction medium is about 0.05 M to about 0.40 M. In some embodiments, the concentration of the surfactant in the reaction medium is about 0.05 M to about 0.30 M. In some embodiments, the concentration of the surfactant in the reaction medium is about 0.05 M to about 0.20 M. In some embodiments, the concentration of the surfactant in the reaction medium is about 0.10 M to about 0.20 M. In some embodiments, the concentration of the surfactant in the reaction medium is about 0.10 M to about 0.15 M. In some embodiments, the concentration of the surfactant in the reaction medium is about 0.15 M to about 0.20 M. In some embodiments, the concentration of the surfactant in the reaction medium is about 0.15 M.

In one embodiment, the reaction medium is exposed to microwave irradiation at about 100 W to 1200 W. In one embodiment, the reaction medium is exposed to microwave irradiation at about 120 W to 300 W. In one embodiment, the reaction medium is exposed to microwave irradiation at about 140 W to 300 W. In one embodiment, the reaction medium is exposed to microwave irradiation at about 160 W to 300 W. In one embodiment, the reaction medium is exposed to microwave irradiation at about 180 W to 300 W. In one embodiment, the reaction medium is exposed to microwave irradiation at about 200 W to 300 W. In one embodiment, the reaction medium is exposed to microwave irradiation at about 220 W to 300 W. In one embodiment, the reaction medium is exposed to microwave irradiation at about 240 W to 300 W. In one embodiment, the reaction medium is exposed to microwave irradiation at about 260 W to 300 W. In one embodiment, the reaction medium is exposed to microwave irradiation at about 280 W to 300 W. In one embodiment, the reaction medium is exposed to microwave irradiation at about 120 W to about 280 W. In one embodiment, the reaction medium is exposed to microwave irradiation at about 140 W to about 260 W. In one embodiment, the reaction medium is exposed to microwave irradiation at about 160 W to about 240 W. In one embodiment, the reaction medium is exposed to microwave irradiation at about 180 W to about 220 W. In one embodiment, the reaction medium is exposed to microwave irradiation at about 200 to 1100 W. In one embodiment, the reaction medium is exposed to microwave irradiation at about 300 to 1000 W. In one embodiment, the reaction medium is exposed to microwave irradiation at about 400 to 900 W. In one embodiment, the reaction medium is exposed to microwave irradiation at about 500 to 800 W. In one embodiment, the reaction medium is exposed to microwave irradiation at about 100 W to about 200 W. In one embodiment, the reaction medium is exposed to microwave irradiation at about 120 W to about 200 W. In one embodiment, the reaction medium is exposed to microwave irradiation at about 140 W to about 200 W. In one embodiment, the reaction medium is exposed to microwave irradiation at about 160 W to about 200 W. In one embodiment, the reaction medium is exposed to microwave irradiation at about 180 W to about 200 W. In one embodiment, the reaction medium is exposed to microwave irradiation at about 120 W to about 180 W. In one embodiment, the reaction medium is exposed to microwave irradiation at about 140 W to 160 W. In one embodiment, the reaction medium is exposed to microwave irradiation at about 100 W to about 150 W. In one embodiment, the reaction medium is exposed to microwave irradiation at about 150 W to about 200 W. In one embodiment, the reaction medium is exposed to microwave irradiation at about 200 W to about 250 W. In one embodiment, the reaction medium is exposed to microwave irradiation at about 250 W to about 300 W. In one embodiment, the reaction medium is exposed to microwave irradiation at about 300 W to about 350 W. In one embodiment, the reaction medium is exposed to microwave irradiation at about 350 W to about 400 W. In one embodiment, the reaction medium is exposed to microwave irradiation at about 400 W to about 450 W. In one embodiment, the reaction medium is exposed to microwave irradiation at about 450 W to about 500 W. In one embodiment, the reaction medium is exposed to microwave irradiation at about 500 W to about 600 W. In one embodiment, the reaction medium is exposed to microwave irradiation at about 600 W to about 700 W. In one embodiment, the reaction medium is exposed to microwave irradiation at about 700 W to about 800 W. In one embodiment, the reaction medium is exposed to microwave irradiation at about 800 W to about 900 W. In one embodiment, the reaction medium is exposed to microwave irradiation at about 900 W to about 1000 W. In one embodiment, the reaction medium is exposed to microwave irradiation at about 1000 W to about 1100 W. In one embodiment, the reaction medium is exposed to microwave irradiation at about 1100 W to about 1200 W.

In one embodiment, the reaction medium is exposed to microwave irradiation at a temperature of about 100° C. to about 300° C. In one embodiment, the reaction medium is exposed to microwave irradiation at a temperature of about 110° C. to about 290° C. In one embodiment, the reaction medium is exposed to microwave irradiation at a temperature of about 120° C. to about 280° C. In one embodiment, the reaction medium is exposed to microwave irradiation at a temperature of about 130° C. to about 270° C. In one embodiment, the reaction medium is exposed to microwave irradiation at a temperature of about 140° C. to about 260° C. In one embodiment, the reaction medium is exposed to microwave irradiation at a temperature of about 150° C. to about 250° C. In one embodiment, the reaction medium is exposed to microwave irradiation at a temperature of about 160° C. to about 240° C. In one embodiment, the reaction medium is exposed to microwave irradiation at a temperature of about 170° C. to about 230° C. In one embodiment, the reaction medium is exposed to microwave irradiation at a temperature of about 100° C. to about 200° C. In one embodiment, the reaction medium is exposed to microwave irradiation at a temperature of about 110° C. to about 190° C. In one embodiment, the reaction medium is exposed to microwave irradiation at a temperature of about 120° C. to about 190° C. In one embodiment, the reaction medium is exposed to microwave irradiation at a temperature of about 130° C. to about 180° C. In one embodiment, the reaction medium is exposed to microwave irradiation at a temperature of about 140° C. to about 170° C. In one embodiment, the reaction medium is exposed to microwave irradiation at a temperature of about 140° C. to about 160° C. In one embodiment, the reaction medium is exposed to microwave irradiation at a temperature of about 100° C. to about 110° C. In one embodiment, the reaction medium is exposed to microwave irradiation at a temperature of about 110° C. to about 120° C. In one embodiment, the reaction medium is exposed to microwave irradiation at a temperature of about 120° C. to about 130° C. In one embodiment, the reaction medium is exposed to microwave irradiation at a temperature of about 130° C. to about 140° C. In one embodiment, the reaction medium is exposed to microwave irradiation at a temperature of about 140° C. to about 145° C. In one embodiment, the reaction medium is exposed to microwave irradiation at a temperature of about 145° C. to about 150° C. In one embodiment, the reaction medium is exposed to microwave irradiation at a temperature of about 150° C. to about 155° C. In one embodiment, the reaction medium is exposed to microwave irradiation at a temperature of about 155° C. to about 160° C. In one embodiment, the reaction medium is exposed to microwave irradiation at a temperature of about 160° C. to about 170° C. In one embodiment, the reaction medium is exposed to microwave irradiation at a temperature of about 170° C. to about 180° C. In one embodiment, the reaction medium is exposed to microwave irradiation at a temperature of about 180° C. to about 190° C. In one embodiment, the reaction medium is exposed to microwave irradiation at a temperature of about 190° C. to about 200° C. In one embodiment, the reaction medium is exposed to microwave irradiation at a temperature of about 200° C. to about 210° C. In one embodiment, the reaction medium is exposed to microwave irradiation at a temperature of about 210° C. to about 220° C.

In one embodiment, the reaction medium is exposed to microwave irradiation for about 1 to 60 minutes. In one embodiment, the reaction medium is exposed to microwave irradiation for about 1 to 50 minutes. In one embodiment, the reaction medium is exposed to microwave irradiation for about 1 to 40 minutes. In one embodiment, the reaction medium is exposed to microwave irradiation for about 1 to 30 minutes. In one embodiment, the reaction medium is exposed to microwave irradiation for about 1 to 20 minutes. In one embodiment, the reaction medium is exposed to microwave irradiation for about 1 to 10 minutes. In one embodiment, the reaction medium is exposed to microwave irradiation for about 5 to 60 minutes.

In one embodiment, the reaction medium is exposed to microwave irradiation for about 10 to 60 minutes. In one embodiment, the reaction medium is exposed to microwave irradiation for about 20 to 60 minutes. In one embodiment, the reaction medium is exposed to microwave irradiation for about 1 to 10 minutes. In one embodiment, the reaction medium is exposed to microwave irradiation for about 10 to 15 minutes. In one embodiment, the reaction medium is exposed to microwave irradiation for about 15 to 20 minutes. In one embodiment, the reaction medium is exposed to microwave irradiation for about 20 to 25 minutes. In one embodiment, the reaction medium is exposed to microwave irradiation for about 25 to 30 minutes. In one embodiment, the reaction medium is exposed to microwave irradiation for about 30 to 40 minutes. In one embodiment, the reaction medium is exposed to microwave irradiation for about 40 to 50 minutes. In one embodiment, the reaction medium is exposed to microwave irradiation for about 50 to 60 minutes.

### Methods of Use

The present invention is further drawn to, in part, a method of sensing analytes comprising synthesizing a nanomaterial by combining in a reaction medium at least five salts comprising a metal and a bidentate ligand, adding a surfactant, adding a compound which contains at least one carbonyl, exposing the reaction medium to microwave irradiation, and exposing the nanomaterial to analytes in a solution.

In some embodiments, the nanomaterial is carbon supported. In some embodiments, the nanomaterial is dispersed on graphene oxide. In some embodiments, the nanomaterial is ultrasonicated with graphene oxide. In some embodiments, the nanomaterial is manually dispersed on the graphene oxide. In some embodiments, the graphene oxide is a sheet. In some embodiments, the graphene oxide is planar. In some embodiments, the graphene oxide is two-dimensional. In some embodiments, the nanomaterial is anchored to the carbon support via van der Waals interactions. In some embodiments, the nanomaterial is anchored to the carbon support via electrostatic interactions.

In one embodiment, the average particle size of the nanomaterial on the carbon support is about 7 to 8 nm. In one embodiment, the average particle size of the nanomaterial on the carbon support is about 8 to 9 nm. In one embodiment, the average particle size of the nanomaterial on the carbon support is about 9 to 10 nm. In one embodiment, the average particle size of the nanomaterial on the carbon support is about 10 to 11 nm. In one embodiment, the average particle size of the nanomaterial on the carbon support is about 11 to 12 nm. In one embodiment, the average particle size of the nanomaterial on the carbon support is about 12 to 13 nm. In one embodiment, the average particle size of the nanomaterial on the carbon support is about 13 to 14 nm. In one embodiment, the average particle size of the nanomaterial on the carbon support is about 14 to 15 nm. In one embodiment, the average particle size of the nanomaterial on the carbon support is about 15 to 16 nm.

In some embodiments, the nanomaterial is used as a nanozyme. In one embodiment, the nanomaterial is an electrochemical sensor. In one embodiment, the nanomaterial is a colorimetric sensor. In one embodiment, the nanomaterial is a peroxidase-mimicking material. In one embodiment, the nanomaterial is drop-cast onto screen printed electrodes (SPEs).

Exemplary analytes include, but are not limited to, steroids, hormones, antioxidants, oxidants, thiol-containing compounds, combinations thereof, and derivatives thereof. In one embodiment, the analyte is cortisol. In one embodiment, the analyte is glutathione. In one embodiment, the analyte is hydrogen peroxide.

In several embodiments, the analytes are found in a biological fluid. In one embodiment, the analytes are in aqueous solution. In one embodiment, the analytes are in organic solution. In one embodiment, the analytes are in a bodily fluid. Exemplary bodily fluids include, but are not limited to, sweat, whole blood, urine, stool, saliva, lymph fluid, cerebrospinal fluid, synovial fluid, cystic fluid, ascites, pleural effusion, fluid obtained from a pregnant woman in the first trimester, fluid obtained from a pregnant woman in the second trimester, fluid obtained from a pregnant woman in the third trimester, maternal blood, amniotic fluid, chorionic villus sample, fluid from a preimplantation embryo, maternal urine, maternal saliva, placental sample, fetal blood, lavage, cervical vaginal fluid, interstitial fluid, ocular fluid, blood, plasma, serum, sputum, feces, semen, mucous, lymph, nasal lavage, eye lavage, peritoneal cavity lavage, vaginal lavage, bladder lavage, rectal lavage, fine needle aspiration of spinal fluid, and synovial fluid aspiration. In one embodiment, the analytes are found in sweat. In one embodiment, the analytes are detected in a fluid using a device comprising the present invention.

In one embodiment, the analytes can be sensed by the nanomaterial at concentrations of about 0.01 μM to about 0.50 μM. In one embodiment, the analytes can be sensed by the nanomaterial at concentrations of about 0.01 μM to about 0.02 μM. In one embodiment, the analytes can be sensed by the nanomaterial at concentrations of about 0.02 μM to about 0.03 μM. In one embodiment, the analytes can be sensed by the nanomaterial at concentrations of about 0.03 μM to about 0.04 μM. In one embodiment, the analytes can be sensed by the nanomaterial at concentrations of about 0.04 μM to about 0.05 μM. In one embodiment, the analytes can be sensed by the nanomaterial at concentrations of about 0.05 μM to about 0.06 μM. In one embodiment, the analytes can be sensed by the nanomaterial at concentrations of about 0.06 μM to about 0.07 μM. In one embodiment, the analytes can be sensed by the nanomaterial at concentrations of about 0.07 μM to about 0.08 μM. In one embodiment, the analytes can be sensed by the nanomaterial at concentrations of about 0.08 μM to about 0.09 μM. In one embodiment, the analytes can be sensed by the nanomaterial at concentrations of about 0.09 μM to about 0.10 μM. In one embodiment, the analytes can be sensed by the nanomaterial at concentrations of about 0.10 μM to about 0.15 μM. In one embodiment, the analytes can be sensed by the nanomaterial at concentrations of about 0.15 μM to about 0.20 μM. In one embodiment, the analytes can be sensed by the nanomaterial at concentrations of about 0.20 μM to about 0.25 μM. In one embodiment, the analytes can be sensed by the nanomaterial at concentrations of about 0.25 μM to about 0.30 μM. In one embodiment, the analytes can be sensed by the nanomaterial at concentrations of about 0.30 μM to about 0.35 μM. In one embodiment, the analytes can be sensed by the nanomaterial at concentrations of about 0.35 μM to about 0.40 μM. In one embodiment, the analytes can be sensed by the nanomaterial at concentrations of about 0.40 μM to about 0.45 μM. In one embodiment, the analytes can be sensed by the nanomaterial at concentrations of about 0.45 μM to about 0.50 μM. In several embodiments, the analytes can be sensed by the nanomaterial at concentrations above 0.50 μM.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

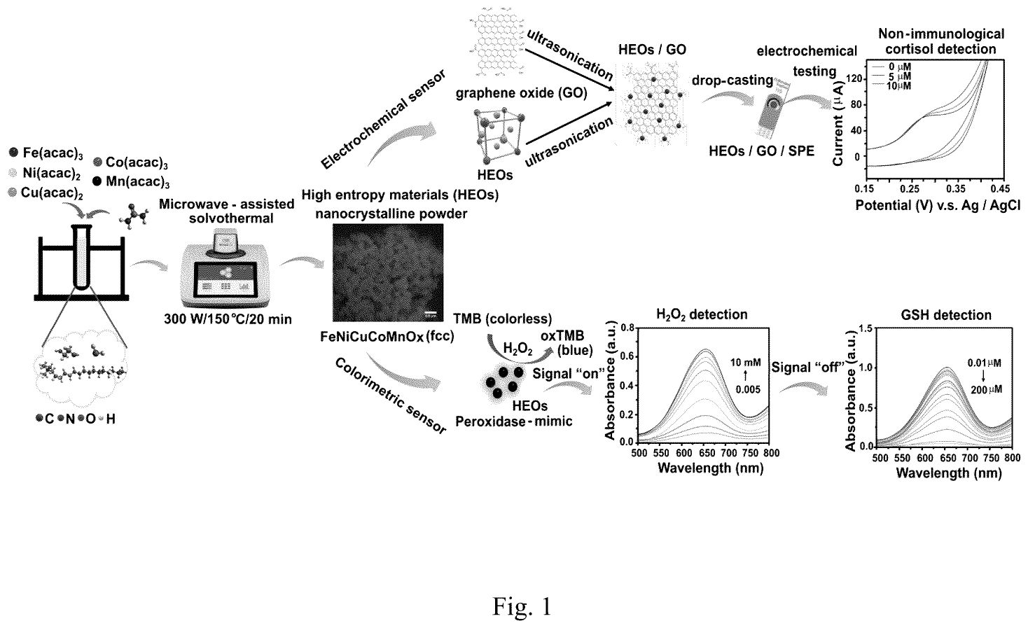

In this work, a novel one-pot microwave-assisted reaction is developed for the preparation and formation of nanostructured HEOs (i.e., Fe—Co—Mn—Ni—Cu oxide) with extraordinary catalytic activities as either electrocatalysts or redox catalysts for detecting multiple biomolecules in integrated bifunctional sensing modules (FIG. 1). Nanostructured HEOs provided large surface area and surface exposure of the active sites for heterogeneous interface catalysis. More oxygen vacancies and abundant oxygen-containing functional groups also facilitated superior catalytic activity towards diverse biomarkers oxidation reactions. This work provides feasible and effective strategies and platforms for the catalytic application of high entropy oxides in biomarker detection.

### Example 1: Microwave-Assisted Synthesis of (FeCoMnNiCu)Oₓ HEOs

As a proof of concept, a novel one-pot microwave-assisted synthesis of (FeCoMnNiCu)Oₓ HEOs were synthesized in this work and its catalytic performance in electrocatalysis and redox catalysis were explored.

Microwave-assisted reactions help to yield products via an effective method with shortened reaction times and improved reaction selectivities, where microwave radiation achieves an efficient internal “in core” volume heating by coupling microwave energy directly to the molecules in the reaction mixture. Thus, microwave irradiation techniques can operate at low temperatures, are eco-friendly, and can be used in highly efficient energy transformations to synthesize various nanostructured materials.

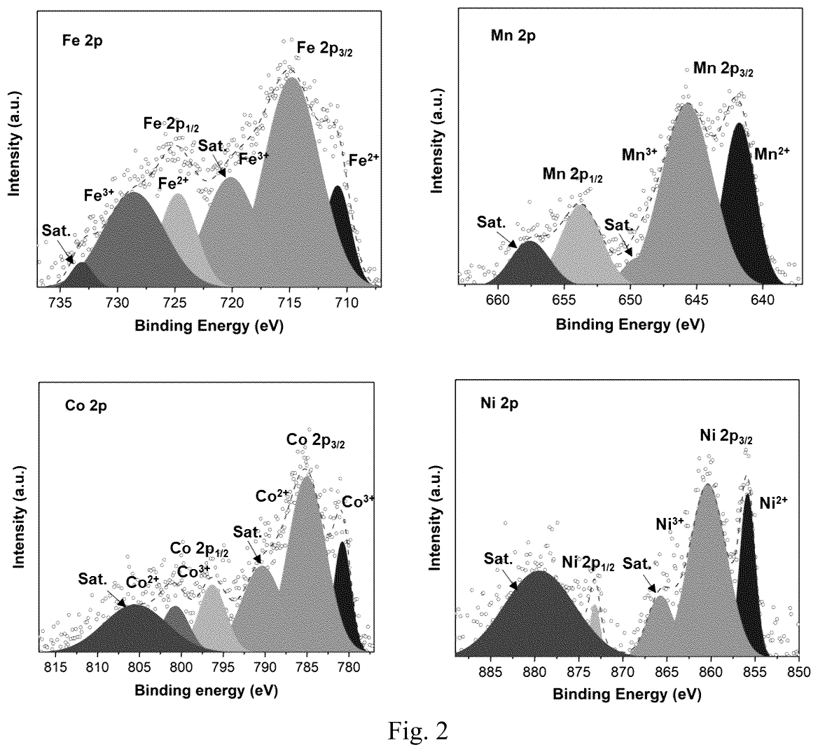

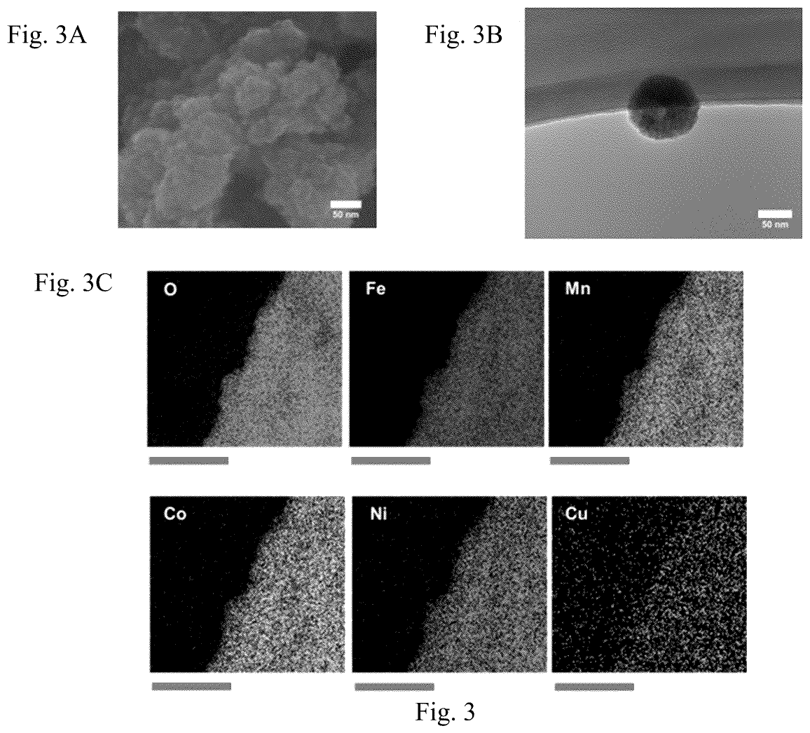

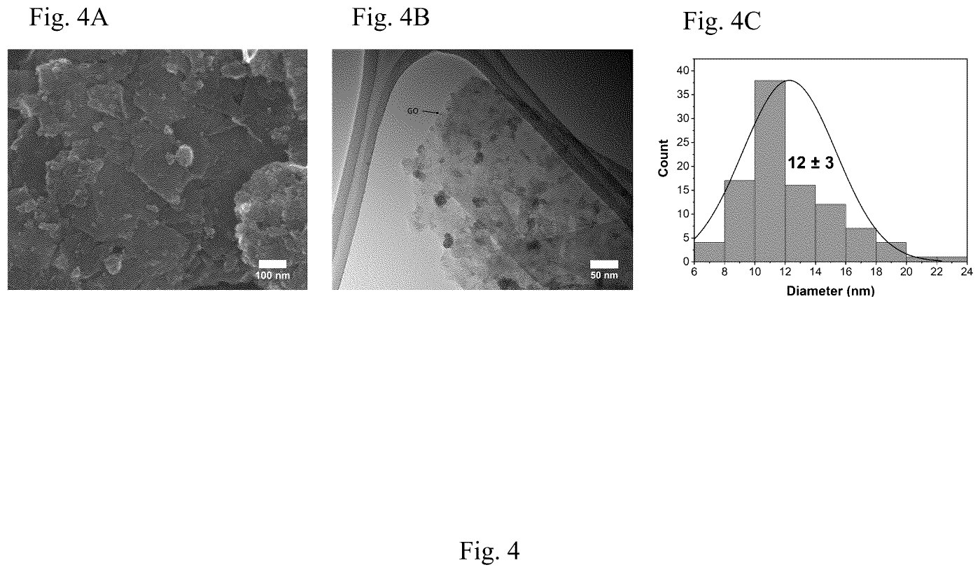

The synthesis of (FeCoMnNiCu) Ox HEOs was carried out in this study using a feasible one-pot microwave reaction. The structure-directing agents, cetyltrimethylammonium chloride (CTAC) and urea, were dissolved in the reaction medium of ethylene glycol and distilled (DI) water, to inhibit random growth of the nanostructured HEOs. Meanwhile, five metal salts (Fe(acac)₃, Ni(acac)₂, Cu(acac)₂, Co(acac)₃, Mn(acac)₃) were chosen as cation precursors in the system. These transition metals were chosen as contributing cations based on their good redox behavior and similar elemental properties such as radius and diffusion speed, allowing them to form high entropy structures (FIG. 2). During the microwave-assisted solvothermal procedure, these metal acetylacetones were hydrolyzed with the assistance of the cationic surfactant of CTAC and led to the formation of a mesoporous assembled structure whose morphological properties are shown in the scanning transmission electron microscopy image (FIG. 3A) and transmission electron microscopy (TEM) image (FIG. 3B). The decomposition of urea not only releases carbon dioxide gas, increasing pressure, but also forms a weakly alkaline buffer in the reaction system and provides a protective reduced environment for transition metals. Acetylacetones as complex agents could also inhibit the hydrolysis rate for preventing rapid precipitates and favoring the architecture of ordered mesoporous structures. The morphology of HEOs obtained from low magnification of scanning electron microscopy (SEM) and TEM images was quasi-spherical with holey structure (FIG. 3A, FIG. 3B). Furthermore, the HEO nanoparticles were dispersed evenly on the two-dimensional graphene oxides which acted as supports to anchor and disperse the active catalysts via van der Waals and electrostatic effects (FIG. 4A, FIG. 4B). The TEM image showed that the average particle size loaded on the GO was approximately 12 nm (FIG. 4C).

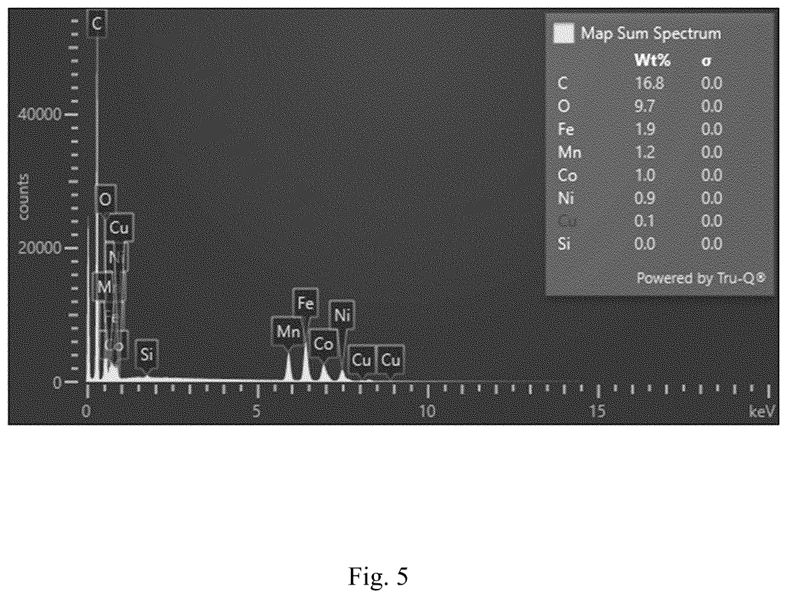

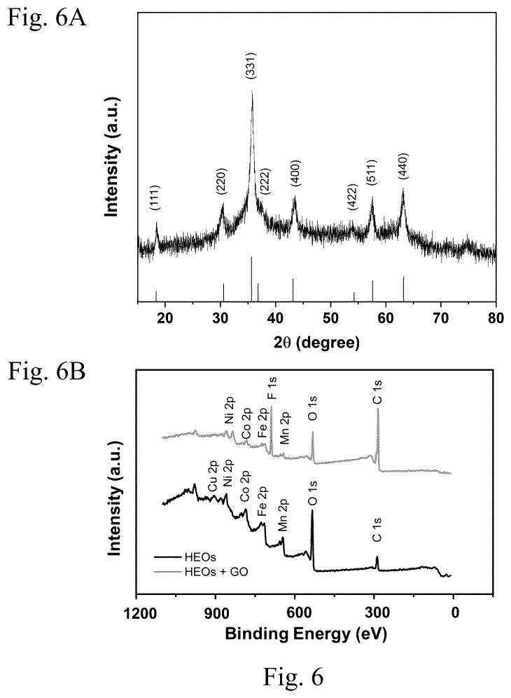

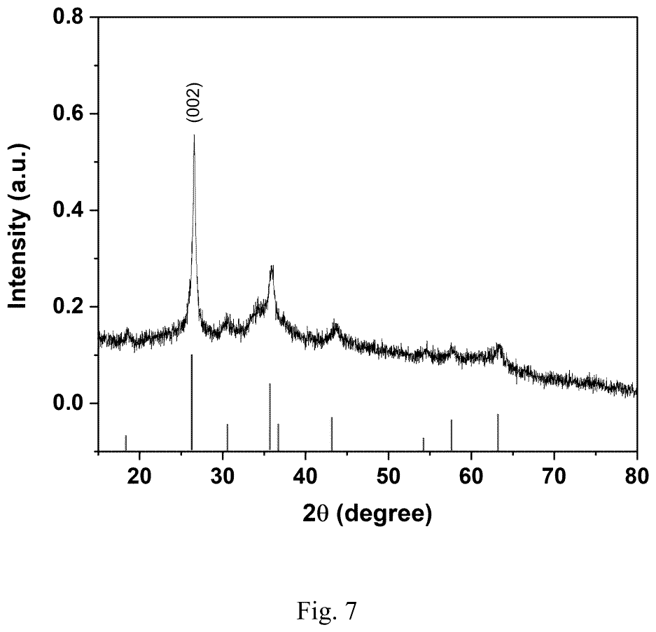

To further confirm the spatial distribution of five metal species in HEOs, the energy-dispersion spectroscopy (EDS) elemental mapping (FIG. 3C, FIG. 5) was carried out and results indicated that Fe, Mn, Co, Ni, Cu, and O were uniformly dispersed in the HEOs without tendency of segregation. It was discovered that the elemental ratio analysis revealed that Cu was less occupied in the HEOs. This can be attributed to the octahedral conformations in coordination complexes, which results in the lowest energy configuration and maximum stability. X-ray diffraction (XRD) pattern was conducted to characterize the crystal structure of HEOs using Cu Ka as the radiation source. Eight diffraction peaks could be well indexed to (111), (220), (331), (222), (400), (422), (511) and (400) planes of spinel phase structure (FIG. 6A). This pattern is in accordance with the reference pattern of JCPDS no.23-1237. The XRD results confirmed that the obtained HEOs are face-centered cubic (FCC) single-phase materials without impurities. Subsequently, the XRD pattern of the HEOs/GO composites displayed multiphase mixture peaks, among which an obvious peak belonging to the graphitic carbon on the (002) lattice plane was observed (FIG. 7).

Furthermore, x-ray photoelectron spectroscopy (XPS) was performed to detect the surface elements and chemical states of the catalyst. The XPS survey spectrum of the HEOs and

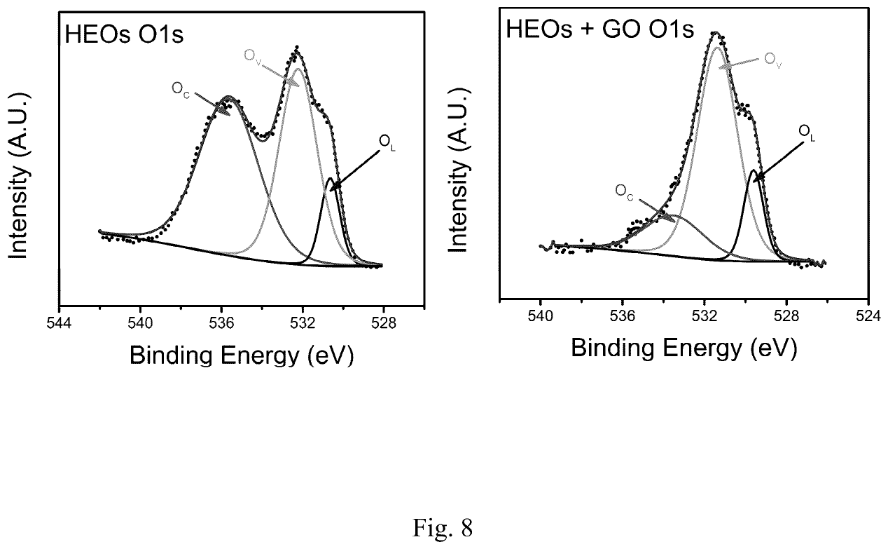

HEOs/GO composites confirmed the presence of Cu, Ni, Co, Fe, Mn, and O elements signals (FIG. 2, FIG. 6B, FIG. 8,). Notably, the tested sample of the HEOs/GO composites were recycled from the mixture of the reaction medium, which utilized a Nafion solution as the prepared reaction medium, as evidenced by the presence of a fluorine signal and the negligible presence of a copper signal in the survey (FIG. 6B).

### Example 2: Catalytic and Electrocatalytic Activity of HEOs as Nanozymes in Cortisol Monitoring

Heterogenous catalysts made of HEOs applied to the electrode surface have shown potential for cortisol detection due to their distinct redox properties. To create an electrochemical non-enzymatic cortisol sensor with an amplified active surface area and catalytic sites, two-dimensional graphene oxide (GO) can be used as a carbon-based support wherein nanoparticles are conjugated and dispersed onto the GO surface.

In addition to serving as electrocatalysts, HEOs also exhibit excellent enzyme-mimetic activity as redox catalysts, making them promising for detecting diverse biomarkers in colorimetric sensors. Widespread attention has been drawn to the potential application of HEOs in disease diagnosis and therapy, particularly in resource-limited areas or primary medical institutions. Glutathione (GSH), a sulfhydryl-containing tripeptide thiol and a type of endogenous antioxidant, is essential to maintain redox homeostasis with the functions of defending toxins and scavenging free radicals. Clinic diagnostic microenvironment of GSH relates to diseases, including aging, liver damage, acquired immunodeficiency syndrome, cancer and so on. Overexpressed GSH in cancer cells is the distinctive feature to screen cancer cells from normal ones, and monitoring the level of intracellular GSH provides useful information and guidance for the occurrence, development, and prognosis of cancer, especially many tumor-specific diagnoses and treatment platforms. Thus, accurate detection of GSH is vital to access human health. HEOs-based biosensors for GSH detection with demanding catalytic activity and clarifying detection mechanism remains an exciting promise. Given quantum dots have the advantage of low background interference in absorbance spectroscopy, the catalytic activity of HEOs for colorimetric biomarker monitoring can be studied without employing GO.

This work solves the aforementioned concerns by utilizing HEOs-based inorganic nanomaterials as electrochemical non-enzymatic cortisol sensors. The sensing procedure is achieved through the direct oxidation of cortisol on the electrode surface, utilizing the diverse redox behaviors of various valence metal ions. It is noteworthy that two-dimensional graphene oxide (GO) as carbon-supported materials is essential for integrating the non-enzymatic cortisol sensor, which act as the support to anchor and disperse the active metals and promote efficient electron kinetics in electrocatalysis. This increases the density of the active site and enhances electrocatalytic activities by utilizing the large surface area of GO for easier surface functionalization and efficient charge-transfer processes. The use of conjugated carbon-supported nanomaterials to anchor and disperse HEO nanoparticles is only for their role as electrocatalysts in the integration into a non-enzymatic cortisol sensor.

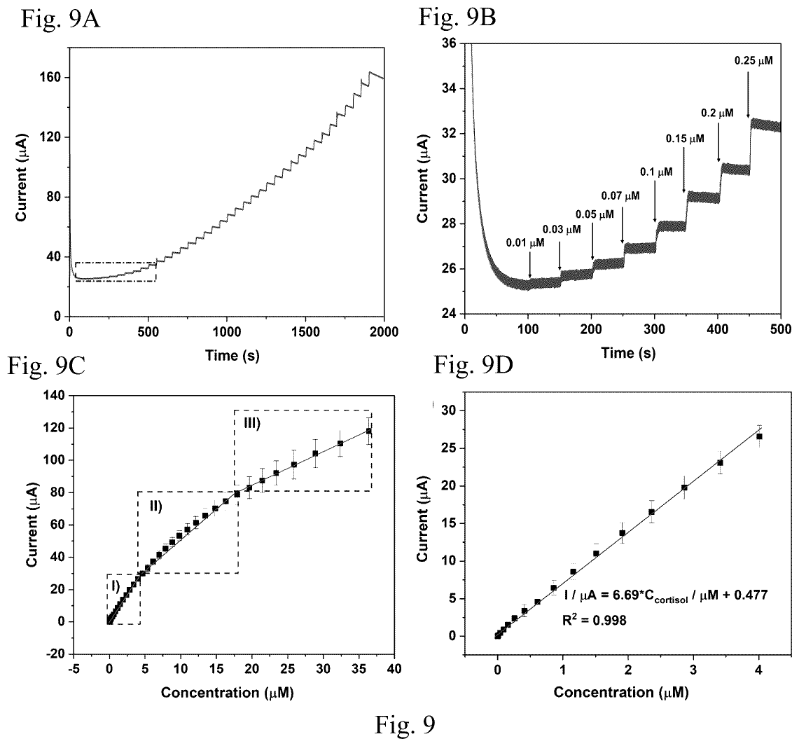

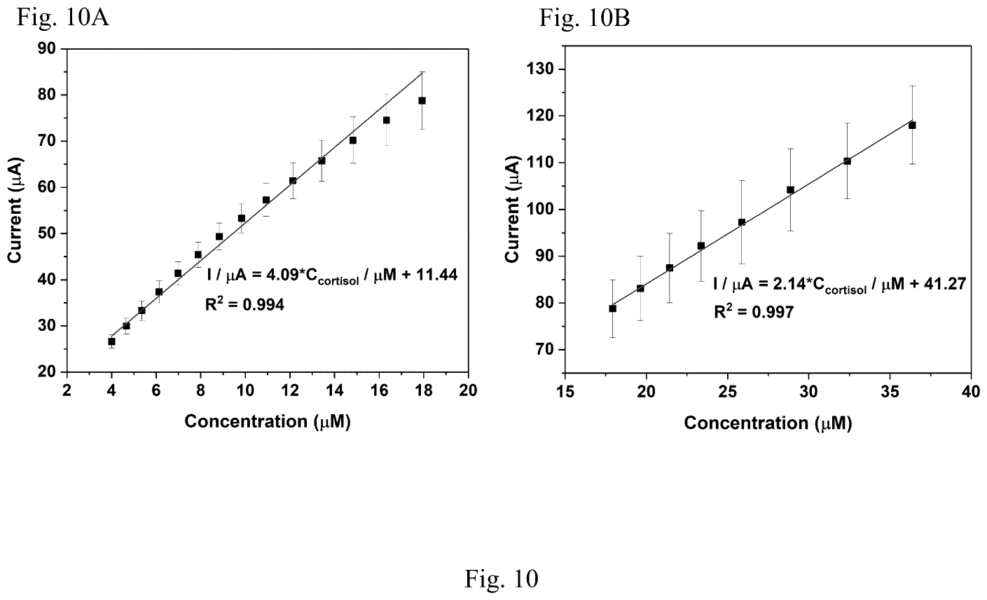

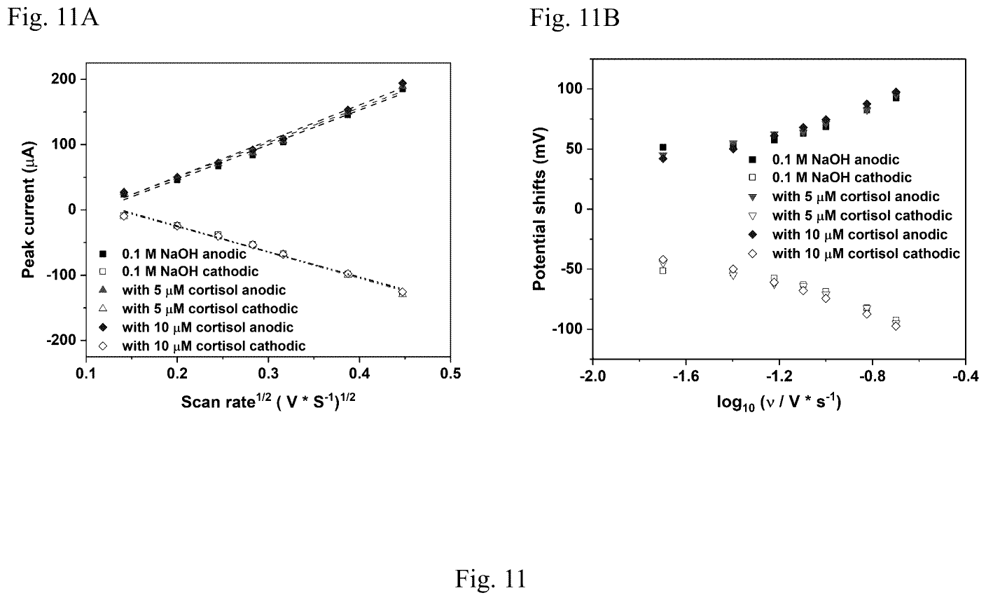

Electrochemical impedance spectroscopy (EIS) was utilized to investigate the charge-transfer resistance of HEOs. The steep straight line indicates infinite charge-transfer resistance, and the semicircle plot depicts the trend of phase angle variation with the frequency, where the plot in low frequency and high frequency represents interface reaction charge transfer and the electron transfer process associated with the formation of surface oxidative species, respectively (FIG. 9A, FIG. 9B, FIG. 9C, FIG. 9D, FIG. 10A, FIG. 10B, FIG. 11A, FIG. 11B).

Amperometric measurements of cortisol were performed using an alkaline NaOH solution as the supporting electrolyte. Cortisol solutions were added in successive steps to the stirring electrolyte solution at an applied potential of 0.35 V, resulting in real-time responsive current signals that were periodically recorded. By measuring the changes in current signals upon adding different concentrations of cortisol, the sensor was able to detect and quantify cortisol levels. The electron transfer rate of redox reactions was determined using a CV data-processing algorithm based on the extended Marcus theory. The experiments were conducted in 0.1 M NaOH electrolyte with various cortisol systems.

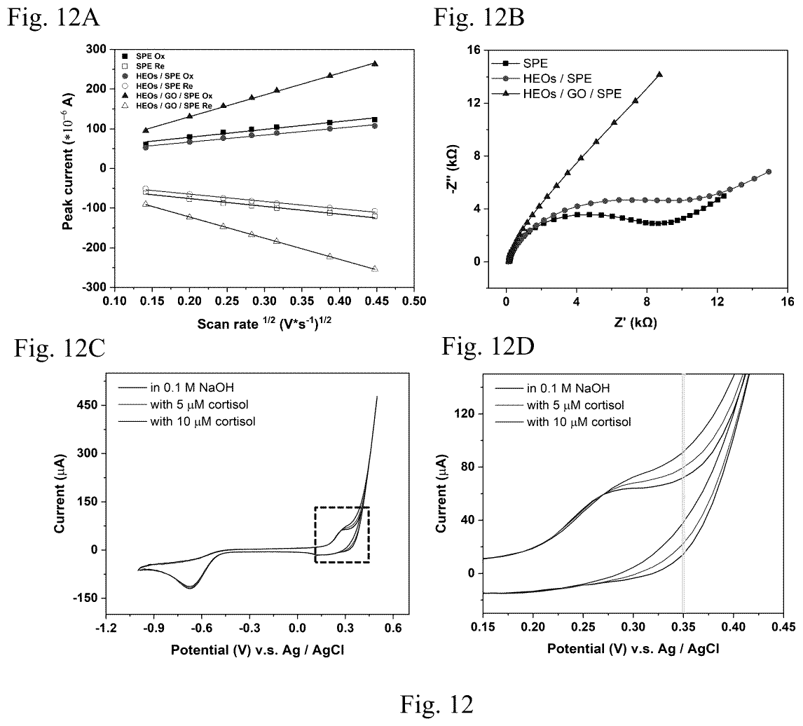

The catalytic mechanism of electrochemical sensors was dependent on the formation of the various valence metal redox species pair (e.g., M(II)/M(III)), where higher valence state M(III) with excellent electrocatalytic properties oxidizes cortisol species present on the electrode surface, accompanied by a reduced M(II) in the system and M(III) is also regenerated at enough potential for next cortisol species oxidation (FIG. 12A, FIG. 12B, FIG. 12C, FIG. 12D). The electrochemical impedance spectroscopy was performed in 0.1 M KCl and 5 mM [Fe(CN)₆]^{3-/4-} by setting the working electrode voltage at 0.0 V vs the reference electrode Ag/AgCl within the frequency range from 100 kHz to 0.1 Hz.

### Example 3: Enzyme-Mimetic and Redox Catalytic Activity of HEOs

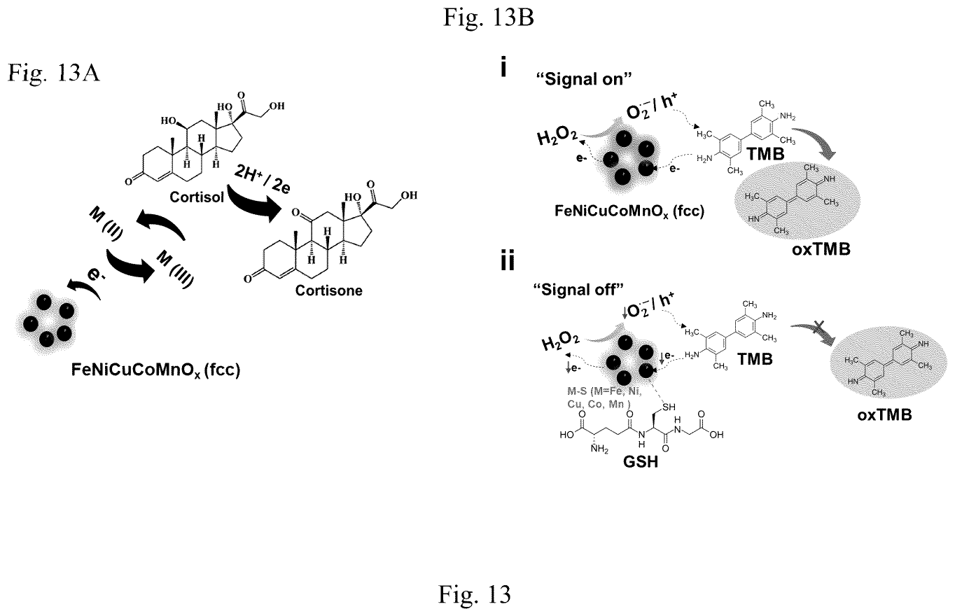

HEOs exhibit excellent enzyme-mimetic activity as redox catalysts, making them not only work as electrocatalysts for cortisol detection (FIG. 13A), but also as promising candidates for detecting diverse biomarkers in colorimetric sensors (FIG. 13B). The enzyme-mimetic activity of HEOs was explored by using 3,3′,5,5′-tetramethylbenzidine (TMB) as a chromogenic indicator, which transforms from colorless TMB to blue-colored ox-TMB, and the color intensity provides information about the catalytic reaction. GSH functions as an endogenous antioxidant and competes with oxTMB to recover its reduced state, resulting in decreased color intensity with the addition of GSH.

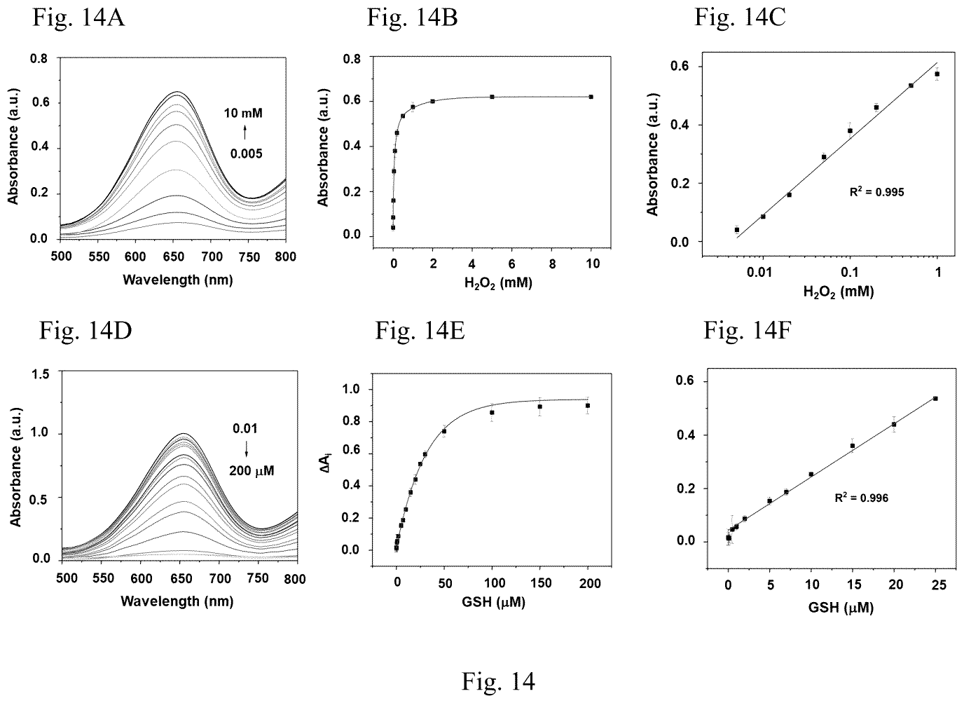

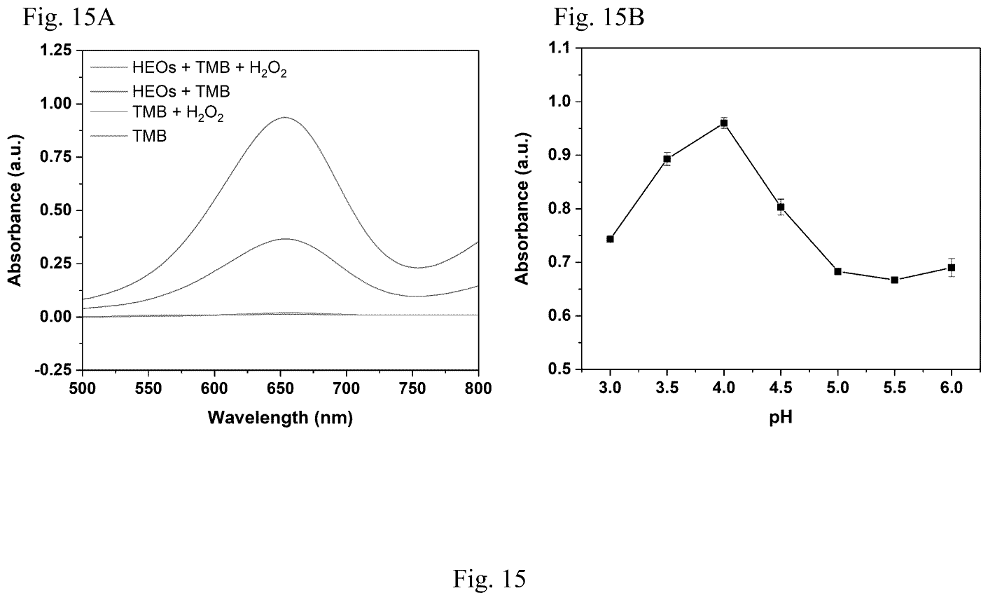

The general catalytic mechanism of nanozymes with peroxidase/oxidase-like activity is based on the process where TMB can be absorbed on the nanozyme surface and donate the lone-pair electrons of −NH₂ moiety to the nanozyme, enhancing electron density and mobility of the nanozyme and consequently accelerating the electron transfer from nanozyme to electron acceptor (e.g., H₂O₂/O₂). In the colorimetric assays for target detection, upon the addition of components containing thiol (—SH) groups, such as GSH/L-Cys, the absorbance value attenuated remarkably, attributing to the consumption of ROS by reductive [SH] group (FIG. 14A, FIG. 14B, FIG. 14C, FIG. 14D, FIG. 14E, FIG. 14F, FIG. 15A).

The peroxidase-mimic properties are closely relevant to pH volume in the system, where the preferred visible, blue-colored ox-TMB was observed at pH 4. The electronegative properties of TMB caused adsorption on the surface of the nanozyme via electrostatic and π-π interactions. With increased pH in the system, the surface of the nanozyme becomes more negative, inhibiting adsorption of TMB molecules onto the surface (FIG. 15B).

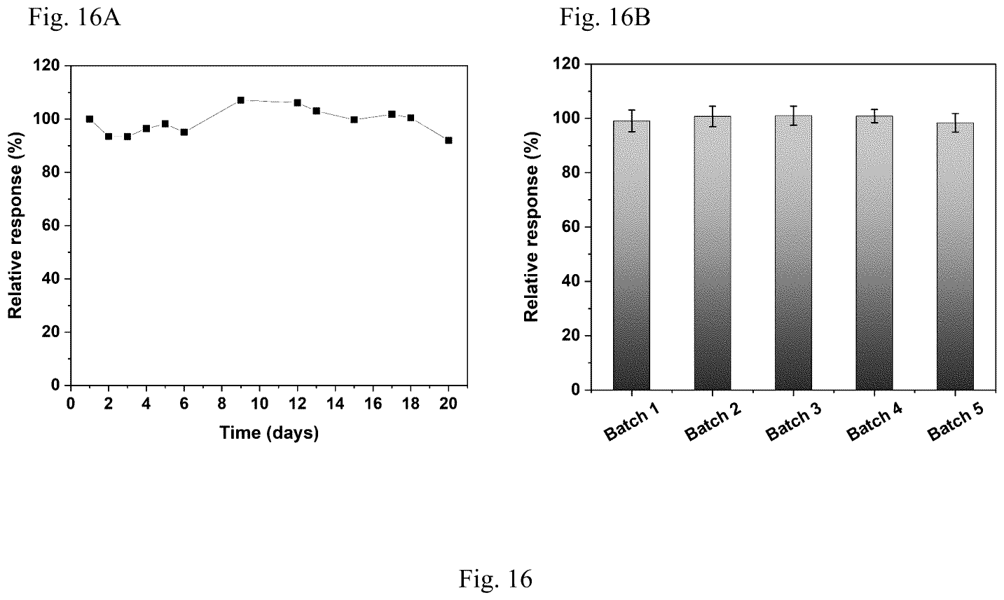

To evaluate the stability of HEOs/GO towards cortisol detecting over 20 days, HEOs/GO were exposed to a constant temperature of 25° C. in an ambient environment while monitoring its output signal (FIG. 16A). To evaluate the reproducibility of the sensor, five batches were prepared using the same protocol and materials and output signals of each sensor were tested in response to a standard analyte concentration (FIG. 16B).

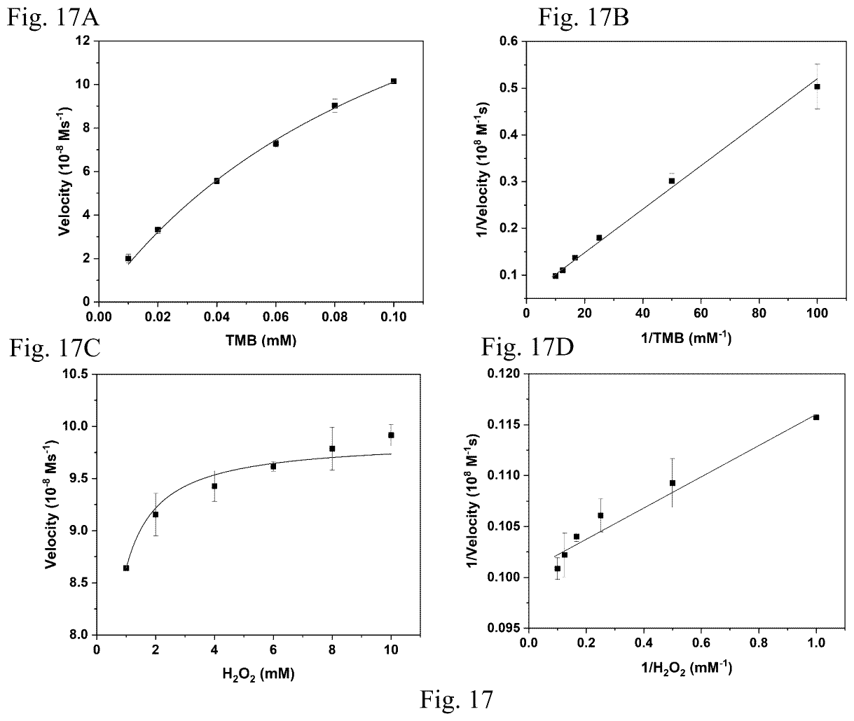

Steady-state kinetic assays of HEOs towards TMB were conducted by mixing 20 μL of HEOs catalysts (1 mg/mL) with 100 μL of H₂O₂ (0.1 M) and various concentrations of TMB (50 μL) in 830 μL of acetate buffer solution (0.2 M, pH 4.0) in a 1.0 mL cuvette with a path length of 1.0 cm at room temperature. The mixture was immediately initiated by stirring for seconds, and then absorbances at 652 nm were recorded at 10-second intervals for 1 minute using a UV-vis spectrophotometer. To evaluate the steady-state kinetic assay towards H₂O₂, the concentration of TMB in the system was fixed and the same procedure was used (FIG. 17A, FIG. 17B, FIG. 17C, FIG. 17D).

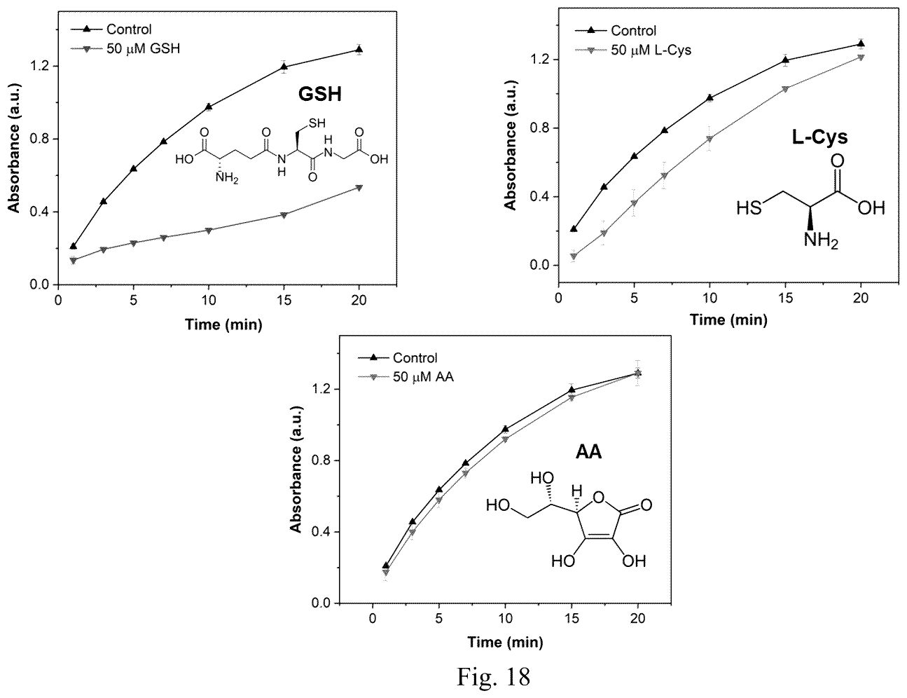

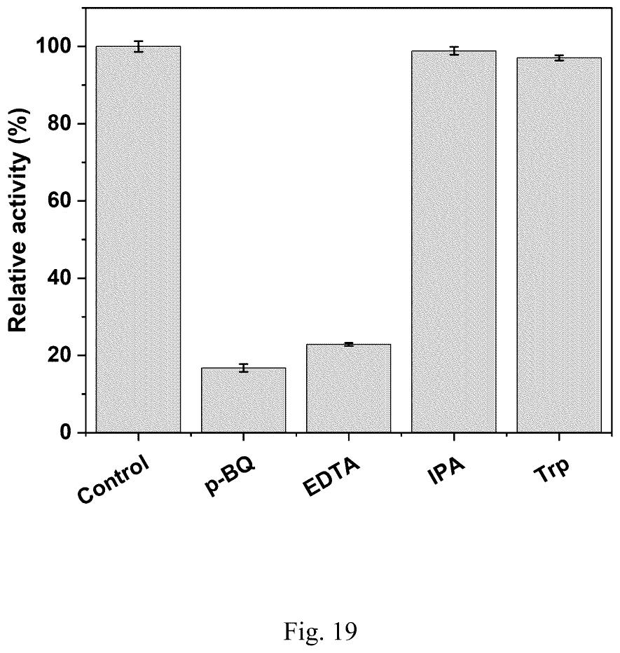

To obtain absorbance data of GSH, L-Cys, and AA over time, reactions were conducted by mixing 20 μL of HEOs catalysts (1 mg/mL) with 100 μL of H₂O₂ (0.1 M), 100 μL of GSH/L-Cys/AA (0.5 mM), and 50 μL of TMB (2 mM) in 730 μL of acetate buffer solution (0.2 M, pH 4.0). The absorbance of the mixture was recorded at 652 nm at 1, 3, 5, 7, 10, and 15-minute intervals for a period of 20 minutes (FIG. 18).

To test the catalytic mechanism of peroxidase mimicking with 2 mM radical scavengers (e.g., 1,4-benzoquinone (superoxide anion radical, O₂^{·-}), ethylenediaminetetraacetic acid (hole, h⁺), isopropyl alcohol (hydroxyl radical, ·OH), and L-Tryptophan (singlet oxygen, ¹O₂)), reactions were prepared by mixing 20 μL of HEOs catalysts (1 mg/mL) with 100 μL of H₂O₂ (0.1 M), 50 μL of radical scavengers (40 mM), and 50 μL of TMB (2 mM) in 780 μL of acetate buffer solution (0.2 M, pH 4.0). The absorbance of the mixture was recorded at 652 nm after 20 minutes of reaction, and control experiments were conducted without the addition of radical scavengers.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A composition prepared by a process comprising the steps of:
combining in a reaction medium at least five metal salts;
adding at least one surfactant to the reaction medium;
adding at least one compound which contains at least one carbonyl to the reaction medium; and
exposing the reaction medium to microwave irradiation.

2. The composition of claim 1, wherein the metal salts are each independently selected from the group consisting of titanium, vanadium, chromium, manganese, iron, cobalt, nickel, copper, zinc, zirconium, niobium, molybdenum, technetium, ruthenium, rhodium, palladium, silver, cadmium, hafnium, tantalum, tungsten, rhenium, osmium, iridium, platinum, gold, combinations thereof, oxides thereof, and any oxidation state thereof.

3. The composition of claim 1, wherein the metal salts are iron, nickel, copper, cobalt, and manganese.

4. The composition of claim 1, wherein the composition comprises five metal salts wherein the ratio of the metal salts is 1:1:1:1:1.

5. The composition of claim 1, wherein the metal salts further comprise a bidentate ligand, wherein the bidentate ligand is selected from the group consisting of a diketone, an anhydride, an oxalate, a diamine, a diphosphine, a bipyridine, a phenanthroline, a catecholate, combinations thereof, derivatives thereof, and ions thereof.

6. The composition of claim 5, wherein the bidentate ligand is acetylacetonate.

7. The composition of claim 1, wherein the at least one surfactant is a quaternary ammonium salt.

8. The composition of claim 1, wherein the at least one surfactant is cetyltrimethylammonium chloride (CTAC).

9. The composition of claim 1, wherein the at least one compound which contains at least one carbonyl is urea.

10. The composition of claim 1, wherein the step of exposing the reaction medium to microwave irradiation is performed at about 250 W to 350 W.

11. The composition of claim 1, wherein the step of exposing the reaction medium to microwave irradiation is performed at about 100° C. to about 200° C.

12. The composition of claim 1, wherein the step of exposing the reaction medium to microwave irradiation is performed for about 10 to 30 minutes.

13. A nanomaterial comprising the composition of claim 1.

14. A method of sensing analytes comprising the steps of:
providing a nanomaterial comprising at least five metal oxides; and
exposing the nanomaterial to at least one analyte in a solution.

15. The method of claim 14, further comprising the step of dispersing the nanomaterial on graphene oxide.

16. The method of claim 14, wherein the at least one analyte is selected from the group consisting of a steroid, a hormone, an antioxidant, an oxidant, a thiol, combinations thereof, and derivatives thereof.

17. The method of claim 14, wherein the at least one analyte is selected from the group consisting of cortisol, hydrogen peroxide, glutathione, and derivatives thereof.

18. The method of claim 14, wherein the concentration of the at least one analyte in the solution is lower than 0.50 μM.

19. The method of claim 14, wherein the nanomaterial is a nanozyme.

20. The method of claim 14, wherein the nanomaterial is an electrochemical sensor or a colorimetric sensor.

21. (canceled)
